(19) United States
(12) Patent Application Publication
(10) Pub. No.: US 2013/0313410 A1
(43) Pub. Date: Nov. 28, 2013

(54) SOLID-STATE IMAGING ELEMENT, METHOD OF DRIVING SOLID-STATE IMAGING ELEMENT, AND IMAGING DEVICE

(71) Applicant: FUJIFILM CORPORATION, Tokyo (JP)

(72) Inventor: Takashi GOTO, Ashigarakami-gun (JP)

(73) Assignee: FUJIFILM CORPORATION, Tokyo (JP)

(21) Appl. No.: 13/946,897

(22) Filed: Jul. 19, 2013

Related U.S. Application Data
(63) Continuation of application No. PCT/JP2011/076324, filed on Nov. 15, 2011.

(30) Foreign Application Priority Data
Jan. 20, 2011 (JP) 2011-010282

(51) Int. Cl. H04N 5/378

(52) U.S. Cl. CPC H04N 5/378
USPC 250/208.1

(57) ABSTRACT

A solid-state imaging element 100 includes a control unit 104 that performs, in each frame, driving to inject electric charge into a storage unit 11 from a power source supplying reset voltage by controlling the reset voltage supplied to a reset Tr 31 and to discharge some of the electric charge that has been injected into the storage unit 11 to the power source by controlling the reset voltage.

### CROSS REFERENCE TO RELATED APPLICATION

This is a continuation of International Application No. PCT/JP2011/076324 filed on Nov. 15, 2011, and claims priority from Japanese Patent Application No. 2011-010282, filed on Jan. 20, 2011, the entire disclosures of which are incorporated herein by reference.

### TECHNICAL FIELD

The present invention relates to a solid-state imaging element, a method of driving the solid-state imaging element, and an imaging device.

### RELATED ART

A photoelectric converting layer-stacked solid-state imaging element, in which photoelectric converting elements that include a pair of electrodes and photoelectric converting layers interposed by the electrodes are provided on a silicon substrate, and which causes electric charge generated in the photoelectric converting layers to move to the silicon substrate from either of the pair of electrodes to read out signals according to the electric charge so as to be output to the outside using an MOS (Metal Oxide Semiconductor) circuit formed on the silicon substrate, has been proposed (refer to Patent Literature 1).

FIG. 12 is a diagram showing an example of a photoelectric converting element and an MOS readout circuit included in one pixel of such a photoelectric converting layer-stacked solid-state imaging element.

One pixel of the photoelectric converting layer-stacked solid-state imaging element includes a photoelectric converting element including a pixel electrode 40, a counter electrode 42 provided above the pixel electrode 40, and a photoelectric converting layer 41 provided between the pixel electrode 40 and the counter electrode 42, and a signal readout circuit that is formed on a semiconductor substrate to read out signals according to electric charge generated in the photoelectric converting layer 41 of the photoelectric converting element and collected by the pixel electrode 40.

The signal readout circuit has an electric charge storage unit 51 that stores the electric charge collected by the pixel electrode 40, a floating diffusion (FD) 52 to which the electric charge stored in the electric charge storage unit 51 is transferred, a transfer transistor (Tr) 53 that transfers the electric charge stored in the electric charge storage unit 51 to the FD 52, a reset transistor 54 that resets a potential of the FD 52 to be a power source voltage VDD, an output transistor 55 that outputs signals according to a potential of the FD 52, and a selecting transistor 56 for selectively outputting signals output from the output transistor 55 to a signal output line.

A signal readout operation of the photoelectric converting layer-stacked solid-state imaging element having the signal readout circuit configured as above will be described.

FIGS. 13 and 14 are diagrams for describing an example of an operation of one pixel of the photoelectric converting layer-stacked solid-state imaging element shown in FIG. 12. FIGS. 13 and 14 illustrate temporal changes of potentials of the electric charge storage unit 51, the FD 52, and a channel region (Tx) of the transfer transistor 53 positioned therebetween.

During the operation of the solid-state imaging element shown in FIG. 12, frame periods (frames) each of which is constituted by a storage period in which electric charge is stored in the electric charge storage unit 51 and a signal readout period in which signals are read out according to the electric charge stored in the electric charge storage unit 51 during the storage period are repeated. Hereinbelow, an operation performed when light is radiated on the solid-state imaging element only in the first frame and imaging is continued in the second and following frames without performing light radiation (when dark-time imaging is performed in the second and the following frames) will be described.

In an electric charge storage period of the first frame, the transfer transistor 53 is turned off, and electric charge Q1 generated by the photoelectric converting layer 41 is stored in the electric charge storage unit 51, as shown in (a) of FIG. 13. Light radiation on the solid-state imaging element is stopped in the state of (a) of FIG. 13, the FD 52 is reset by turning on the reset transistor 54 ((b) of FIG. 13), then the transfer transistor 53 is turned on, and then the electric charge Q1 stored in the electric charge storage unit 51 is transferred to the FD 52 ((c) of FIG. 13).

Since a difference of potentials between the electric charge storage unit 51 and the channel region Tx is great immediately after the transfer transistor 53 is turned on, signal electric charge is smoothly transferred from the electric charge storage unit 51 to the FD 52. As the transfer of the signal electric charge proceeds, however, the level of the potential of the electric charge storage unit 51 becomes low, and thus the difference of the potentials between the electric charge storage unit 51 and the channel region Tx decreases. For this reason, the transfer transistor 53 is in a weak inversion state, and thus the transfer of the signal electric charge from the electric charge storage unit 51 to the FD 52 stagnates. As a result, even when the transfer is completed after a predetermined time elapses from the start of transfer, some electric charge of the signal electric charge Q1 remains in the electric charge storage unit 51 without being transferred ((d) of FIG. 13). After the completion of the transfer, signals according to the amount of electric charge transferred to the FD 52 are output to the outside via the output transistor 55. After signal readout of the first frame is completed in this manner, an electric charge storage period (dark-time imaging) of a second frame starts ((e) of FIG. 13).

Even though light radiation onto the solid-state imaging element is not performed in the state of (e) of FIG. 13, a slight amount of electric charge Q2 is also generated in the photoelectric converting layer 41 in that case, and then stored in electric charge storage unit 51.

After (e) of FIG. 13, the FD 52 is reset by turning on the reset transistor 54. Accordingly, the electric charge transferred to the FD 52 in the first frame is completely eliminated ((f) of FIG. 13). Then, the transfer transistor 53 is turned on again, and the electric charges (Q1+Q2) in the electric charge storage unit 51 are transferred to the FD 52 ((g) of FIG. 13).

Also in this case, the signal electric charge is transferred from the electric charge storage unit 51 to the FD 52 according to the difference of the potentials between the electric charge storage unit 51 and the channel region Tx. The amount of the transferred signal electric charge is based on the amount of signal electric charges Q1+Q2, but since the transfer transistor 53 is in the weak inversion state as the transfer proceeds in the same manner as in the first frame, some of the electric charge Q1 and some of the electric charge Q2 are left in the electric charge storage unit 51 ((h) of FIG. 14) when the transfer is completed. After the completion of the transfer, signals according to the amount of the electric charge transferred to the FD 52 are output to the outside via the output transistor 55. Since the signals include the signal electric charge Q1 generated from the light radiation of the first frame, an image lag appears for the amount of the signal electric charge Q1.

Then, electric charge Q3 that does not depend on light radiation is stored in the electric charge storage unit 51 ((i) of FIG. 14), the FD 52 is reset ((j) of FIG. 14), then, the transfer transistor 53 is turned on, some of the electric charge Q1, electric charge Q2 and electric charge Q3 is thereby transferred to the FD 52, and when the transfer is completed, some of the electric charge Q1, some of the electric charge Q2, and some of the electric charge Q3 remains in the electric charge storage unit 51 ((k) of FIG. 14).

The amount of signal electric charge stored in the electric charge storage unit 51 during transfer of electric charge in a third imaging frame is smaller than that in the second imaging frame. For this reason, the amount of electric charge remaining in the electric charge storage unit 51 when the transfer of the electric charge is completed, and the amount of electric charge transferred from the electric charge storage unit 51 to the FD 52 during the transfer of the electric charge are smaller than those in the second imaging frame. Thus, the amount of signal electric charge transferred to the FD 52 when the transfer is completed in the third imaging frame is smaller than that in the second imaging frame, and the amount of signals output from the pixels to the outside is also smaller than that in the second imaging frame. Since the signals include signal components based on the signal electric charge Q1 generated from light radiation, the signals appear as an image lag. The signal components based on the signal electric charge Q1 are gradually reduced as imaging frames progress. For this reason, the image lag gets smaller as dark-time imaging is repeated in the second and the following frames.

When the operations are repeated, light radiation is finished, then an n^{th} electric charge storage period ends ((l) of FIG. 14), and the amount of electric charge stored in the electric charge storage unit 51 during the n^{th} electric charge storage period coincides with the amount of electric charge transferred from the electric charge storage unit 51 to the FD 52 when n^{th} electric charge transfer is completed. In this state, no image lag is generated ((m) of FIG. 14).

FIG. 15 is a diagram showing temporal changes of signal outputs of one pixel shown in FIG. 12. In FIG. 15, the signal output level indicated by letter (d) is a signal level according to the potential of the FD 52 in the state of (d) of FIG. 13, and the signal output levels indicated by letters (h), (k), and (m) are signal levels according to the potentials of the FD 52 in the states of (h), (k), and (m) of FIG. 14. As shown in FIG. 15, the signal output does not quickly become uniform in the pixel shown in FIG. 12 even after light radiation is finished, and an image lag is generated over a plurality of frames. Such an image lag over the plurality of frames causes serious deterioration in image quality particularly when a subject moves, or the like.

In the configuration in which the electric charge storage unit 51 is formed on the semiconductor substrate and electric charge stored therein is transferred to the FD 52 as described above, since the amount of the electric charge transferred from the electric charge storage unit 51 to the FD 52 depends not only on the amount of signal electric charge generated in the corresponding frame but also on electric charge previously stored in the electric charge storage unit 51, an image lag is generated, and image quality deteriorates.

As a method to eliminate such an image lag described above, Patent Literature 2 and Patent Literature 3 disclose methods for uniformly maintaining a potential of storage diodes at all times when storage of electric charge is started by using injection diodes to inject electric charge into the storage diodes that store electric charge.

### CITATION LIST

### Patent Literature

Patent Literature 1: JP-A-2005-268479

Patent Literature 2: JP-A-6-164826

Patent Literature 3: JP-A-6-86179

### SUMMARY OF INVENTION

### Technical Problem

However, Patent Literature 2 and Patent Literature 3 are based on the premise that a signal readout circuit formed on a semiconductor substrate is of a CCD (Charge Coupled Device) type, without considering an MOS type that uses a low drive voltage. In addition, in solid-state imaging elements disclosed in Patent Literature 2 and Patent Literature 3, injection diodes need to be formed for each pixel, and pixel sizes thereof are large, and thus, the elements are not suitable for high pixel density. In addition, since the process of forming the injection diodes is required, a manufacturing cost increases.

The present invention takes the above circumstances into consideration, and aims to provide a photoelectric converting layer-stacked solid-state imaging element, and a method of driving the element, and an imaging device with the solid-state imaging element that can attain high image quality, high pixel density, and low cost.

### Solution to Problem

It is a solid-state imaging element of the present invention that has a photoelectric converting layer that is formed above a semiconductor substrate and made of an organic material, and an MOS type signal readout circuit that is formed on the semiconductor substrate and reads out signals according to electric charge generated in the photoelectric converting layer, in which the signal readout circuit includes a first electric charge storage unit that stores electric charge generated in the photoelectric converting layer, a second electric charge storage unit to which the electric charge stored in the first electric charge storage unit is transferred, a transfer transistor that transfers the electric charge stored in the first electric charge storage unit to the second electric charge storage unit, a reset transistor that resets a potential of the second electric charge storage unit, and an output transistor that outputs a signal according to the potential of the second electric charge storage unit, and in which the solid-state imaging element comprises: a control unit that performs, in each frame, driving to inject electric charge into the first electric charge storage unit from a semiconductor region by changing a potential of the semiconductor region in which a power source of the reset transistor is connected from a deep state to a shallow state, and to discharge the electric charge that has been injected into the first electric charge storage unit to the semiconductor region by changing, from this state, the potential of the semiconductor region from the shallow state to a deep state.

It is a method of driving a solid-state imaging element of the present invention that has a photoelectric converting layer that is formed above a semiconductor substrate and made of an organic material, and an MOS type signal readout circuit that is formed on the semiconductor substrate and reads out signals according to electric charge generated in the photoelectric converting layer, in which the signal readout circuit includes a first electric charge storage unit that stores electric charge generated in the photoelectric converting layer, a second electric charge storage unit to which the electric charge stored in the first electric charge storage unit is transferred, a transfer transistor that transfers the electric charge stored in the first electric charge storage unit to the second electric charge storage unit, a reset transistor that resets a potential of the second electric charge storage unit, and an output transistor that outputs a signal according to the potential of the second electric charge storage unit, and in which the method comprises: a drive step of performing, in each frame, driving to inject electric charge into the first electric charge storage unit from a semiconductor region by changing a potential of the semiconductor region in which a power source of the reset transistor is connected from a deep state to a shallow state, and to discharge the electric charge that has been injected into the first electric charge storage unit to the semiconductor region by changing, from this state, the potential of the semiconductor region from the shallow state to a deep state.

It is an imaging device of the present invention comprising: the solid-state imaging element.

### Advantageous Effects of Invention

According to the present invention, it is possible to provide a photoelectric converting layer-stacked solid-state imaging element, and a method of driving the element, and an imaging device with the solid-state imaging element that can attain high image quality, high pixel density, and low cost.

### BRIEF DESCRIPTION OF DRAWINGS

FIG. 1 is a schematic plan diagram of a photoelectric converting layer-stacked solid-state imaging element 100 for describing an embodiment of the present invention.

FIG. 2 is a diagram schematically showing an outlined configuration of a pixel 101 of the solid-state imaging element 100 shown in FIG. 1.

FIG. 3 is a schematic cross-sectional diagram showing an outlined configuration of the pixel 101 of the solid-state imaging element 100 shown in FIG. 1.

FIG. 4 is a diagram showing a modified example of the pixel 101 shown in FIG. 3.

FIG. 5 is a timing chart for describing an imaging operation for one pixel row of the solid-state imaging element 100 shown in FIG. 1.

FIG. 6 is a diagram showing shifts of potentials in a substrate 10 during an imaging operation of the solid-state imaging element 100 shown in FIG. 1.

FIG. 7 is a diagram showing shifts of potentials in the substrate 10 during an imaging operation of the solid-state imaging element 100 shown in FIG. 1.

FIG. 8 is a diagram showing shifts of potentials in the substrate 10 during an imaging operation of the solid-state imaging element 100 shown in FIG. 1.

FIG. 9 is a diagram showing temporal changes of a signal output from the solid-state imaging element 100 through the driving shown in FIG. 5.

FIG. 10 is a diagram showing a circuit configuration example when a readout circuit is shared by two pixels in the solid-state imaging element 100 shown in FIG. 1.

FIG. 11 is a timing chart for describing an imaging operation of the solid-state imaging element in the configuration of the readout circuit shown in FIG. 10.

FIG. 12 is a diagram showing an example of a photoelectric converting element and an MOS circuit included in one pixel of a photoelectric converting layer-stacked solid-state imaging element.

FIG. 13 is a diagram for describing an example of an operation of one pixel of the photoelectric converting layer-stacked solid-state imaging element shown in FIG. 12.

FIG. 14 is a diagram for describing the example of the operation of one pixel of the photoelectric converting layer-stacked solid-state imaging element shown in FIG. 12.

FIG. 15 is a diagram showing temporal changes of a signal output of one pixel shown in FIG. 12.

### DESCRIPTION OF EMBODIMENTS

Hereinafter, an embodiment of the present invention will be described with reference to the drawings.

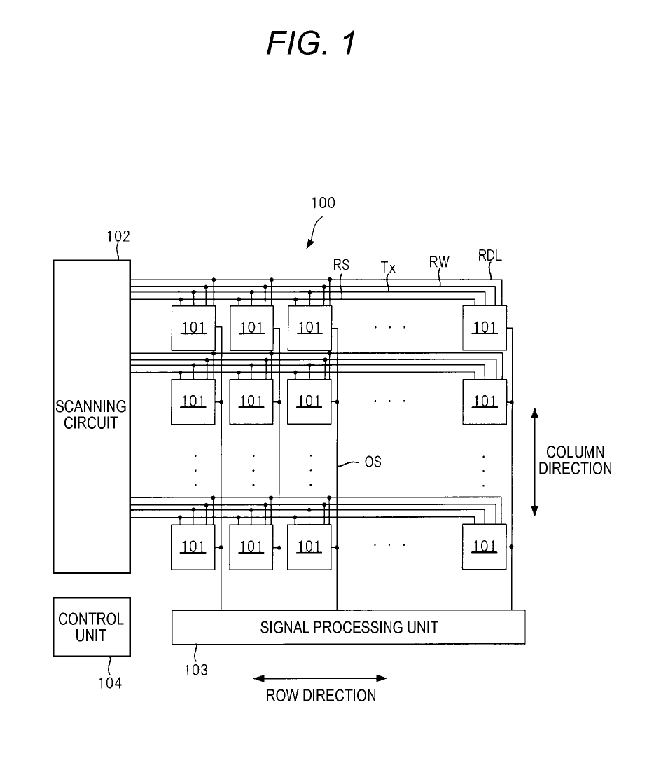

FIG. 1 is a schematic plan diagram of a photoelectric converting layer-stacked solid-state imaging element 100 for describing an embodiment of the present invention. This solid-state imaging element 100 is used by being mounted in imaging devices such as digital cameras, and digital video cameras, imaging modules mounted in electronic endoscopes, and mobile telephones with camera, and the like.

The solid-state imaging element 100 shown in FIG. 1 includes a plurality of pixels 101 arrayed in a two-dimensional shape (a square grid shape in the example of FIG. 1) in a row direction and a column direction orthogonal thereto, a scanning circuit 102 for controlling reading of signals output from the pixels 101, a signal processing unit 103 that processes signals output from each of the pixels 101, and a control unit 104 that controls the overall solid-state imaging element 100.

The scanning circuit 102 is connected to signal readout circuits which will be described later and are included in each of the pixels 101 via reset lines RS, transfer control lines Tx, row selecting lines RW, and reset drain lines RDL. The signal processing unit 103 is connected to each of the pixels 101 via output signal lines OS.

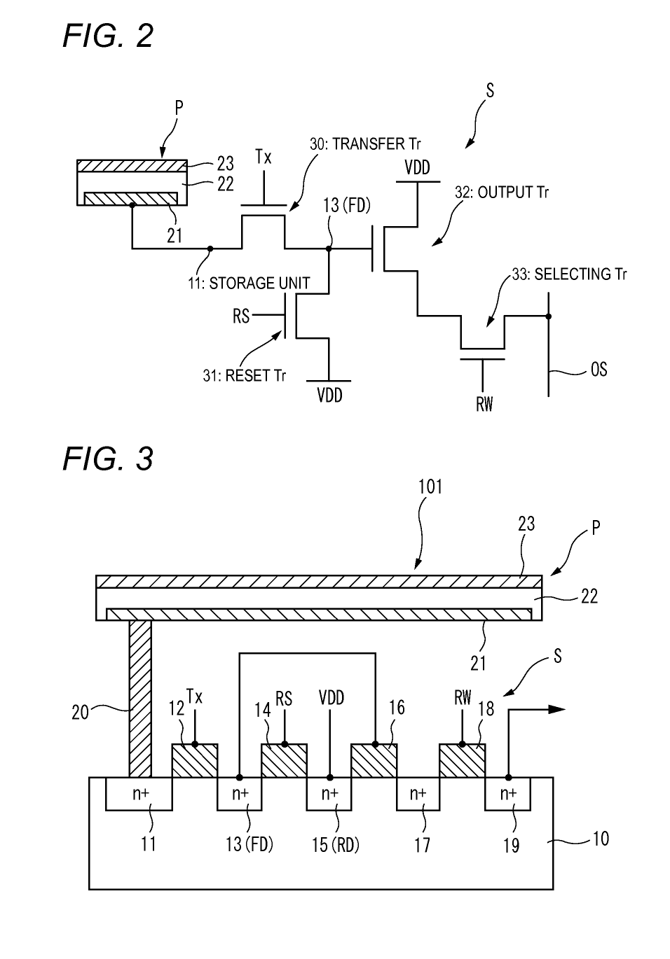

FIG. 2 is a diagram schematically showing an outlined configuration of a pixel 101 of the solid-state imaging element 100 shown in FIG. 1.

As shown in FIG. 2, the pixel 101 includes a photoelectric converting element P formed above a semiconductor substrate and an MOS type signal readout circuit S formed on the semiconductor substrate.

The photoelectric converting element P includes a pixel electrode 21 formed above the semiconductor substrate, a counter electrode 23 formed above the pixel electrode 21, and a photoelectric converting layer 22 provided between the pixel electrode 21 and the counter electrode 23.

Light is incident on the counter electrode 23 from above. Since the counter electrode 23 needs to cause light to be incident on the photoelectric converting layer 22, the counter electrode 23 is formed of a conductive material such as ITO that is transparent with respect to incident light. One counter electrode 23 is configured to be shared by all pixels 101, but may be divided for each pixel 101.

The pixel electrode 21 is a thin film divided for each pixel 101, and formed of a transparent or opaque conductive material (such as ITO, aluminum, or titanium nitride).

The photoelectric converting layer 22 is a layer containing an organic photoelectric converting material that absorbs light having a specific wavelength of incident light and generates electric charge according to the amount of absorbed light. An electric charge blocking layer that suppresses electric charge from being injected from the electrodes to the photoelectric converting layer 22 may be provided between the photoelectric converting layer 22 and the counter electrode 23, or between the photoelectric converting layer 22 and the pixel electrode 21.

A bias voltage is applied to the counter electrode 23 so that electrons in the electric charge generated in the photoelectric converting layer 22 move to the pixel electrode 21 and holes move to the counter electrode 23.

The signal readout circuit S includes an electric charge storage unit 11 that stores electric charge that has moved to the pixel electrode 21, a floating diffusion (FD) 13, a transfer transistor 30 that causes the electric charge stored in the electric charge storage unit 11 to be transferred to the FD 13, a reset transistor 31 that resets a potential of the FD 13, an output transistor 32 that causes signals to be output according to the potential of the FD 13, and a row selecting transistor 33 that causes the signals output from the output transistor 32 to be selectively output to the output signal lines OS. It should be noted that the transistors included in the signal readout circuit S are formed of n-type MOS transistors.

FIG. 3 is a schematic cross-sectional diagram showing an outlined configuration of the pixel 101 of the solid-state imaging element 100 shown in FIG. 1.

The photoelectric converting element P shown in FIG. 2 is formed above a p-type silicon substrate 10 (hereinafter, referred to as a substrate 10) that is the semiconductor substrate, and the signal readout circuit S shown in FIG. 2 is formed on the substrate 10.

The electric charge storage unit 11 which includes an n-type impurity layer and is electrically connected to the pixel electrode 21 is provided inside the substrate 10. The electric charge storage unit 11 and the pixel electrode 21 are connected via a contact wiring 20 that is formed above the substrate 10 and formed of a conductive material. The electric charge storage unit 11 stores electric charge that has been generated in the photoelectric converting layer 22 and moved to the pixel electrode 21.

The floating diffusion (FD) 13 that includes an n-type impurity layer is formed near the electric charge storage unit 11 a little apart therefrom, and a gate electrode 12 of the transfer transistor 30 is formed above the substrate 10 between the electric charge storage unit 11 and the FD 13. The gate electrode 12 is connected to the transfer control line Tx shown in FIG. 1.

A reset drain region (semiconductor region) 15 (hereinafter, referred to as an RD 15) that includes an n-type impurity layer is formed near the FD 13 a little apart therefrom, and a gate electrode 14 of the reset transistor 31 is formed above the substrate 10 between the FD 13 and the RD 15. The gate electrode 14 is connected to the reset line RS shown in FIG. 1. The RD 15 is connected to the reset drain line RDL shown in FIG. 1, and a variable voltage can be supplied to the RD 15 from the control unit 104 via the reset drain line RDL. The RD 15 functions not only as a drain of the reset transistor 31 but also as a drain of the output transistor 32.

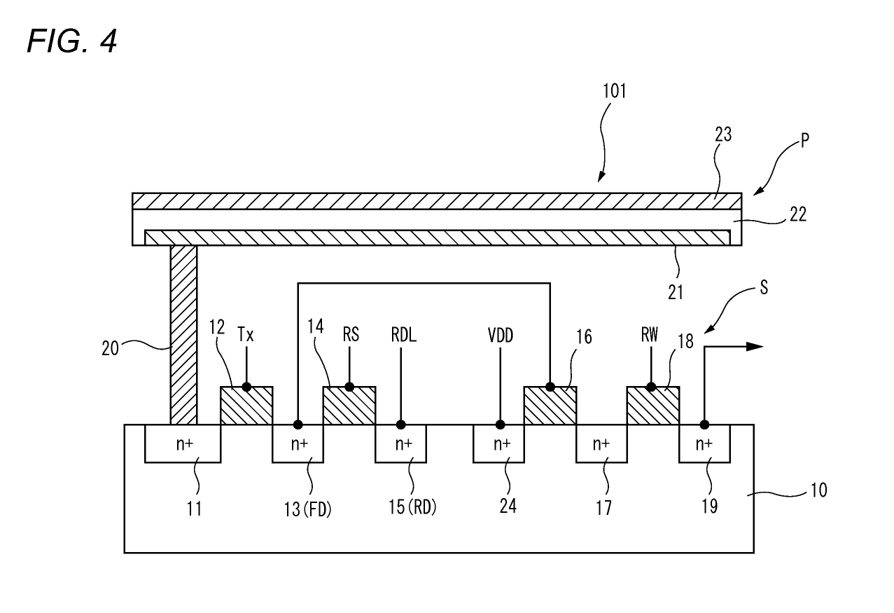

It should be noted that an n-type impurity region 24 that is a drain region of the output transistor 32 may be formed near the RD 15 as shown in FIG. 4, and a power supply voltage VDD of the solid-state imaging element 100 may be supplied thereto. By separating the drain of the reset transistor 31 from the drain of the output transistor 32 as shown in FIG. 4, the same configuration and driving as those of a signal readout circuit of the related art are applied to the output transistor 32 and the following component of the signal readout circuit.

An n-type impurity layer 17 is formed near the RD 15 a little apart therefrom, and a gate electrode 16 of the output transistor 32 is formed above the substrate 10 between the RD 15 and the n-type impurity layer 17. The gate electrode 16 is electrically connected to the FD 13.

An n-type impurity layer 19 is formed near the n-type impurity layer 17 a little apart therefrom, and a gate electrode 18 of the row selecting transistor 33 is formed above the substrate 10 between the n-type impurity layer 17 and the n-type impurity layer 19. The gate electrode 18 is connected to the row selecting line RW shown in FIG. 1.

An operation of the solid-state imaging element 100 configured as above will be described.

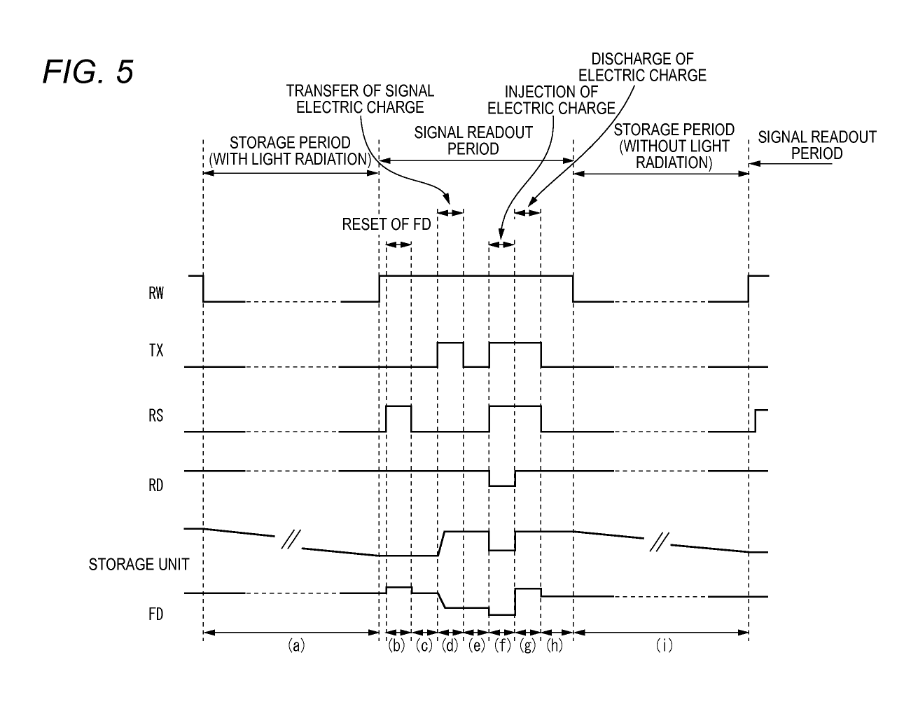

FIG. 5 is a timing chart for describing an imaging operation for one pixel row of the solid-state imaging element 100 shown in FIG. 1. In FIG. 5, “RW” indicates a waveform of a voltage supplied to the row selecting line RW, “Tx” indicates a waveform of a voltage supplied to the transfer control line Tx, “RS” indicates a waveform of a voltage supplied to the reset line RS, “RD” indicates a waveform of a voltage supplied to the RD 15 via the reset drain line RDL, “storage unit” indicates a potential of the electric charge storage unit 11, and “FD” indicates a potential of the FD 13.

During an operation of the solid-state imaging element 100, frame periods (frame) each of which is constituted by a storage period in which electric charge is stored in the electric charge storage unit 11 and a signal readout period in which signals are read out according to the electric charge stored in the electric charge storage unit 11 during the storage period are repeated. Hereinbelow, an operation performed when light is radiated on the solid-state imaging element 100 only in the first frame and imaging is continued in the second and following frames without light radiation (when dark-time imaging is performed in the second and the following frames) will be described.

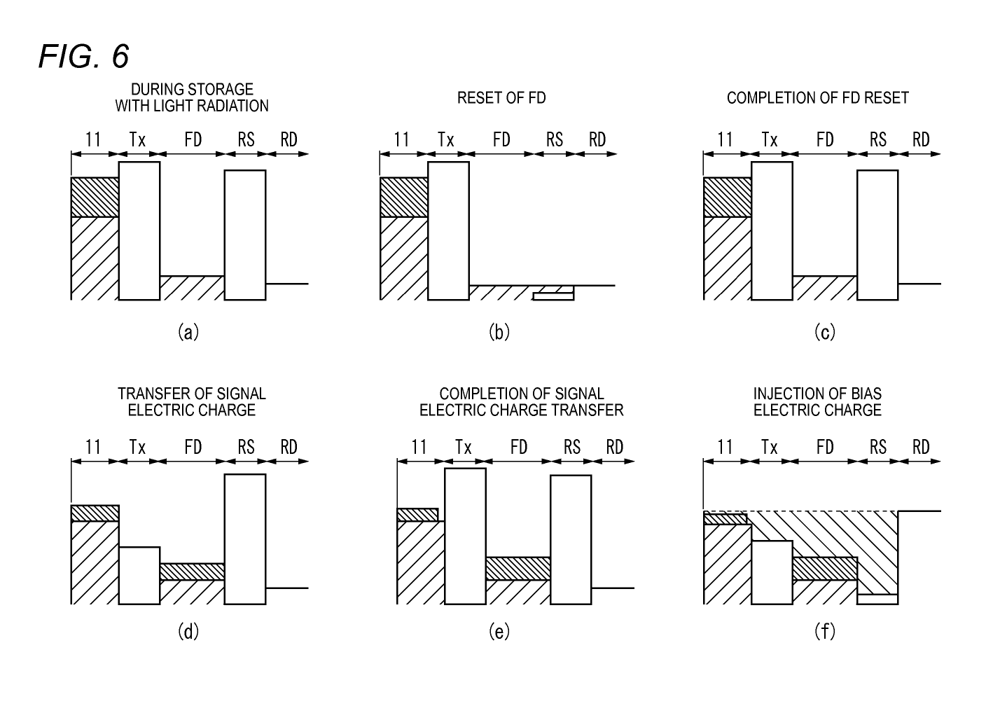

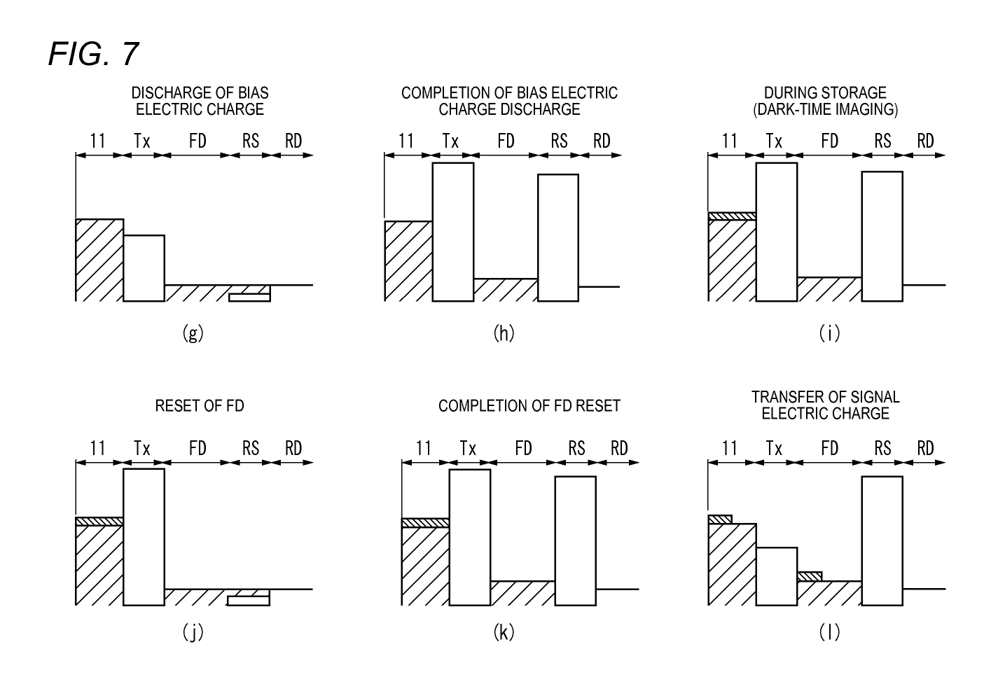

FIGS. 6 to 8 are diagrams showing shifts of potentials in the substrate 10 during an imaging operation of the solid-state imaging element 100 shown in FIG. 1. (a) to (f) of FIG. 6 and (g) to (i) of FIG. 7 are diagrams of potentials in the substrate 10 in each period of (a) to (i) shown in FIG. 5. In FIGS. 6 to 8, “Tx” indicates a potential of a channel region below the gate electrode 12 of the transfer transistor 30, and “RS” indicates a potential of a channel region below the gate electrode 14 of the reset transistor 31.

In a storage period in which light is radiated on the photoelectric converting layer 22, and electric charge generated in the photoelectric converting layer 22 using the light is stored in the electric charge storage unit 11, the control unit 104 controls the scanning circuit 102 to turn off the row selecting transistor 33, the transfer transistor 30, and the reset transistor 31, and then supplies a power source voltage (VDD of about 3 V in general) of the solid-state imaging element 100 to the RD 15. During the storage period, electric charge according to the amount of light incident on the photoelectric converting layer 22 is stored in the electric charge storage unit 11 ((a) of FIGS. 5 and 6). When the transfer transistor 30 is turned off, the potential of the channel region below the gate electrode 12 of the transfer transistor 30 is in a shallow state. When the reset transistor 31 is turned off, the potential of the channel region below the gate electrode 14 of the reset transistor 31 is in a shallow state.

It should be noted that, hereinbelow, it is assumed that light radiation on the solid-state imaging element 100 is stopped at the same time as the end of the storage period of (a) of FIG. 5.

After the storage period ends, the control unit 104 controls the scanning circuit 102 so as to turn on the row selecting transistor 33, then to turn on the reset transistor 31 (deepen the potential of the channel region below the gate electrode 14), and thereby resetting the potential of the FD 13 ((b) of FIGS. 5 and 6).

Next, the control unit 104 controls the scanning circuit 102 to turn off the reset transistor 31, and thereby completing the reset of the FD 13 ((c) of FIGS. 5 and 6). At this point, a signal according to the potential of the FD 13 is output from the output transistor 32, and the signal is output to the signal output lines OS via the selecting transistor 33 as a reference signal.

Next, the control unit 104 controls the scanning circuit 102 to turn on the transfer transistor 30 (deepen the potential of the channel region below the gate electrode 12) so as to transfer the electric charge stored in the electric charge storage unit 11 to the FD 13 ((d) of FIGS. 5 and 6).

Next, the control unit 104 controls the scanning circuit 102 to turn off the transfer transistor 30 so as to complete the transfer of the electric charge stored in the electric charge storage unit 11 to the FD 13 ((e) of FIGS. 5 and 6). At this point, a signal according to the potential of the FD 13 is output from the output transistor 32, and the signal is output to the signal output lines OS via the selecting transistor 33. A signal with low noise can be acquired by acquiring the difference between the signal and the above-described reference signal in the signal processing unit.

Next, the control unit 104 controls the scanning circuit 102 so as to turn on the transfer transistor 30 and the reset transistor 31, and to inject electric charge to the electric charge storage unit 11 from the RD 15 by changing a voltage supplied to the RD 15 from the power source voltage VDD to the potential of the channel region of the transfer transistor 30 decided based solely on a voltage applied to the gate electrode 12 of the transfer transistor 30 and to a value lower than the potential of the channel region of the reset transistor 31 decided based solely on a voltage applied to the gate electrode 14 of the reset transistor 31 ((f) of FIGS. 5 and 6). In the state of (f) of FIG. 6, the potentials of the electric charge storage unit 11, the channel region of the transfer transistor 31, the FD 13, and the channel region of the reset transistor 31 are the same as that of the RD 15.

Next, the control unit 104 controls the scanning circuit 102 so as to return the voltage supplied to the RD 15 to the power source voltage VDD with the transfer transistor 30 and the reset transistor 31 turned on, and to discharge the electric charge injected into the electric charge storage unit 11 to the RD 15 ((g) of FIGS. 5 and 7).

Next, the control unit 104 controls the scanning circuit 102 to turn off the transfer transistor 30 and the reset transistor 31 in a more shallow potential state of the electric charge storage unit 11 than the potential of a transfer channel of the transfer transistor 30 decided based solely on a voltage applied to the gate electrode 12 of the transfer transistor 30, and completes the discharge of the electric charge that has been injected into the electric charge storage unit 11 to the RD 15 ((h) of FIGS. 5 and 7). The potential of the electric charge storage unit 11 in the period (h) of FIG. 5 is decided based on the length of the period (g) of FIG. 7 (the length of the electric charge discharge period), and does not depend on the amount of electric charge that has been originally stored in the electric charge storage unit 11.

After the period (h) of FIG. 7, the period is transitioned to a storage period (a period without light radiation) again, and the control unit 104 performs the same driving as shown in the periods (a) to (h) of FIG. 5 (also including driving in a period between (a) and (b)).

In other words, after the selecting transistor 33 is turned on from the state shown in (i) of FIG. 7, the FD 13 is reset by turning on the reset transistor 31 ((j) of FIG. 7), then the resetting of the FD 13 is completed by turning off the reset transistor 31 ((k) of FIG. 7), and then the electric charge that has been stored in the electric charge storage unit 11 is transferred to the FD 13 by turning on the transfer transistor 30 ((1) of FIG. 7).

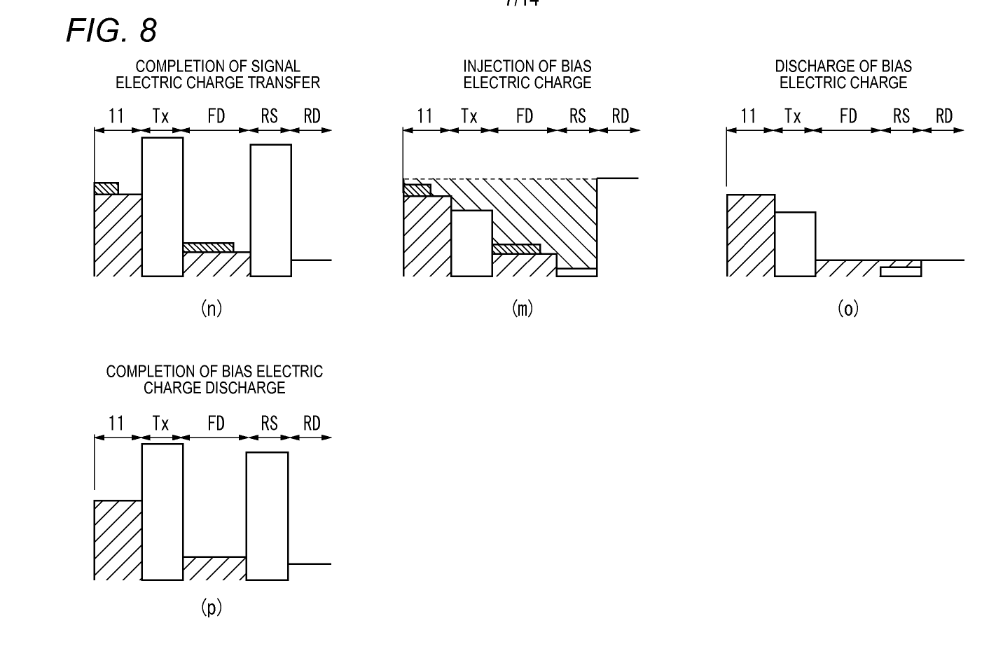

Then, the transfer of the electric charge is completed by turning off the transfer transistor 30 ((n) of FIG. 8), and then electric charge is injected to the electric charge storage unit 11 from the RD 15 by turning on the transfer transistor 30 and the reset transistor 31 and lowering a voltage supplied to the RD 15 ((m) of FIG. 8). Next, discharge of the injected electric charge is performed ((o) of FIG. 8) by returning the potential of the RD 15 to the power source voltage VDD, and then the discharge of the electric charge is completed ((p) of FIG. 8) by turning off the transfer transistor 30 and the reset transistor 31.

The potential of the electric charge storage unit 11 in the state of (p) of FIG. 8 is the same as that of the electric charge storage unit 11 in the state of (h) of FIG. 7. In other words, the electric charge storage unit 11 is initialized without depending on the amount of signal electric charge, and occurrence of an image lag is thereby suppressed.

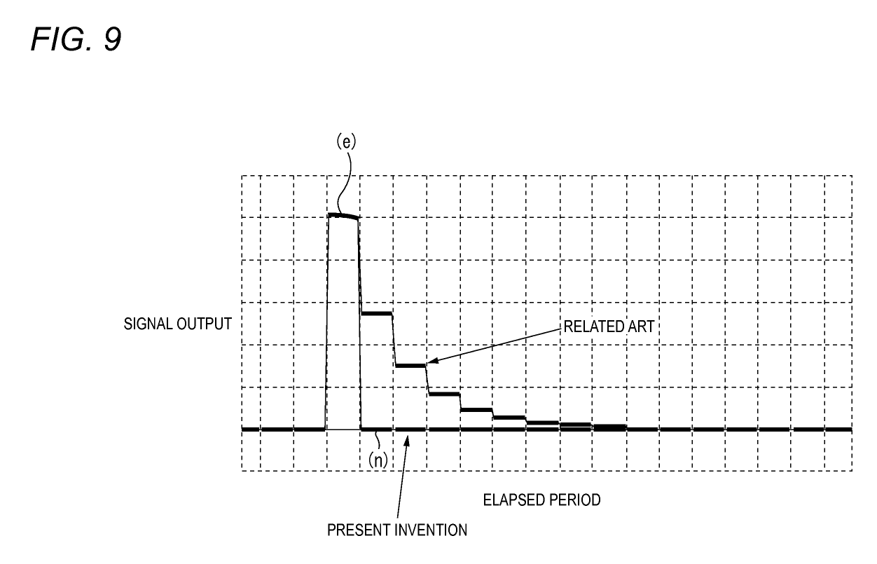

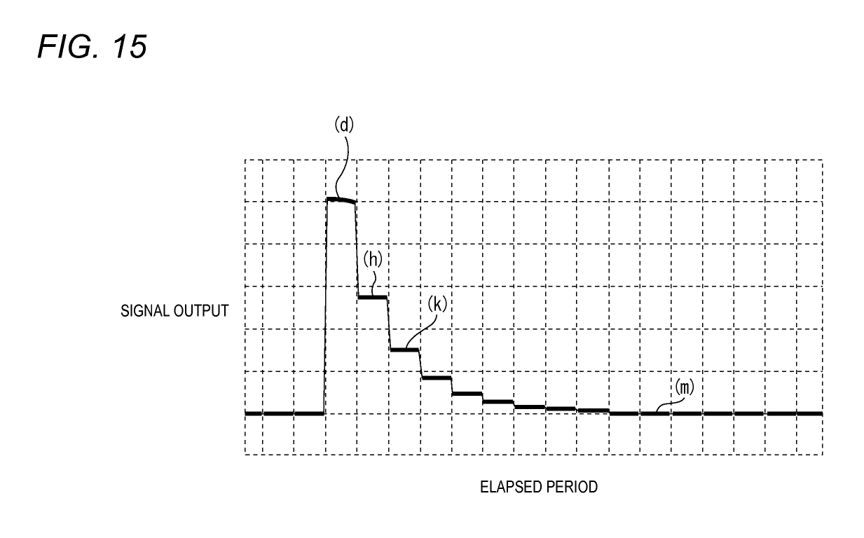

FIG. 9 is a diagram showing temporal changes of a signal output from the solid-state imaging element 100 through the driving shown in FIG. 5. It should be noted that FIG. 9 also shows changes of a signal output shown in FIG. 15 when injection of electric charge is not performed as an “example of the related art.”

A signal output (e) shown in FIG. 9 is a signal according to the potential of the FD 13 in the state of (e) of FIG. 6, and a signal output (n) is a signal according to the potential of the FD 13 in the state of (n) of FIG. 8. As understood from FIG. 9, according to the driving method shown in FIG. 5, the output signal is uniform from the frame after light radiation is finished, and occurrence of an image lag can thereby be suppressed.

As described above, according to the solid-state imaging element 100, electric charge is injected to the electric charge storage unit 11 from the RD 15 of the reset transistor 31 included in the MOS type signal readout circuit S, and the potential of the electric charge storage unit 11 when storage of electric charge starts is uniform for each frame at all times, and thus imaging with high image quality is possible while preventing occurrence of an image lag.

In addition, due to the configuration in which electric charge is injected to the electric charge storage unit 11 from the RD 15 of the reset transistor 31, an image lag can be suppressed without changing the configuration of a solid-state imaging element of the related art using an MOS circuit as the signal readout circuit S. As a result, an increase in the number of manufacturing processes resulting from separate installation of a mechanism for electric charge injection and an increase in a pixel size can be prevented, and low cost and high pixel density can be attained. Furthermore, since the MOS circuit is used as the signal readout circuit S, power consumed can be reduced further than in a CCD type circuit.

In addition, as shown in (f) of FIG. 6 and (m) of FIG. 8, when electric charge is injected to the electric charge storage unit 11 from the RD 15, the solid-state imaging element 100 causes the potential of the channel region of the transfer transistor 30 decided based solely on a voltage applied to the gate electrode 12 of the transfer transistor 30 to be lower than the potential of the channel region of the transfer transistor 30 decided based solely on a voltage applied to the gate electrode 12 of the transfer transistor 30 in the period in which electric charge is stored in the electric charge storage unit 11 by turning on the transfer transistor 30. If electric charge is injected to the electric charge storage unit 11 from the RD 15 without turning on the transfer transistor 30, the potential of the RD 15 needs to be quite shallow, causing an increase in power consumed, but such a problem does not occur in the solid-state imaging element 100.

In addition, the solid-state imaging element 100 discharges the electric charge injected into the electric charge storage unit 11 to the RD 15 while the transfer transistor 30 is turned on, as shown in (g) of FIG. 7 and (o) of FIG. 8, and controls the amount of injected electric charge remaining in the electric charge storage unit 11 according to the time in which the transfer transistor 30 is turned on. In other words, by merely changing the length of the period in which the electric charge injected into the electric charge storage unit 11 is discharged, the amount of the injected electric charge remaining in the electric charge storage unit 11 can be changed. For this reason, by performing driving such as reducing the amount of the injected electric charge remaining in the electric charge storage unit 11 (by changing the length of the period in which the electric charge is discharged according to a captured scene) in order to increase saturation of the electric charge storage unit 11 in, for example, a bright scene, driving appropriate for a scene can also be possible.

In addition, as shown in (g) of FIG. 7 and (o) of FIG. 8, the solid-state imaging element 100 completes the discharge of the electric charge by turning off the transfer transistor 30 in a state in which the potential of the electric charge storage unit 11 is more shallow than the potential of the transfer channel of the transfer transistor 30 when the transfer transistor 30 is turned on (the potential of the channel region of the transfer transistor 30 decided based solely on a voltage applied to the gate electrode 12 of the transfer transistor 30). For this reason, a time required for discharging the electric charge can be shortened in comparison to a case in which the discharge of the electric charge is completed after the potential of the transfer channel of the transfer transistor 30 when the transfer transistor 30 is turned on becomes the same as that of the electric charge storage unit 11.

In the above description, the signal readout circuit S is set to be a circuit that reads out signals according to electrons of electric charge generated in the photoelectric converting layer 22, but is not limited thereto. The signal readout circuit S may be a circuit that reads out signals according to holes of the electric charge generated in the photoelectric converting layer 22 by applying a bias voltage to the pixel electrode 21 so as to move the holes. In the configuration of such a case, the n-type impurity regions in FIG. 3 are all set to be a p-type. In addition, the same potential diagrams shown in FIGS. 6 to 8 are applied to this case, and a voltage supplied to the signal readout circuit S is based on the potential diagrams.

In addition, in the solid-state imaging element 100, a part of the signal readout circuit S may be configured to be shared by adjacent pixels 101. With this configuration, a pixel size can be reduced.

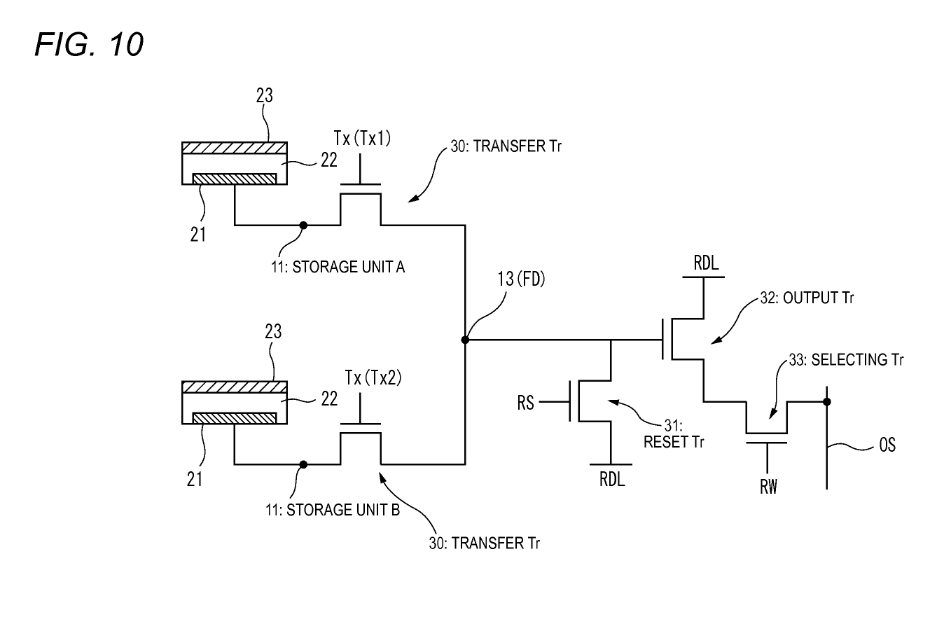

FIG. 10 is a diagram showing an example of the configuration in which a part of the signal readout circuit S is shared by two pixels 101 adjacent in the column direction of the solid-state imaging element 100 shown in FIG. 1.

As shown in FIG. 10, by causing the FD 13, the reset transistor 31, the output transistor 32, and the row selecting transistor 33 to be shared by two pixels 101 adjacent in the column direction, and controlling timings at which the transfer transistors 30 which are included in each of the two pixels 101 are turned on, electric charges stored in the electric charge storage units 11 of the two pixels 101 are individually transferred to the FD 13, and signals according to the stored electric charges can be respectively output to the signal output line OS.

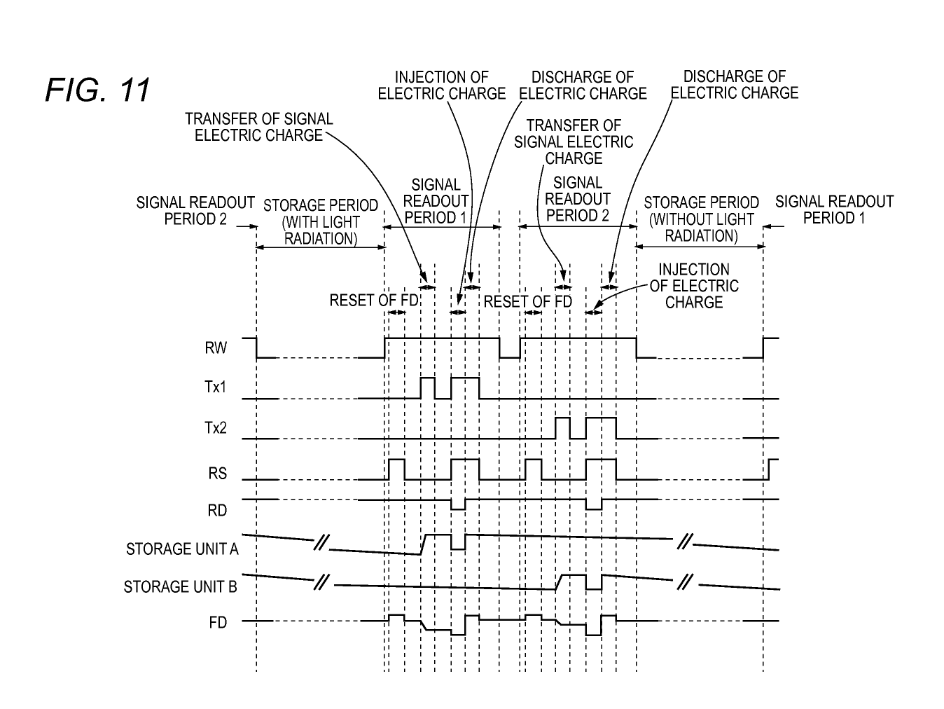

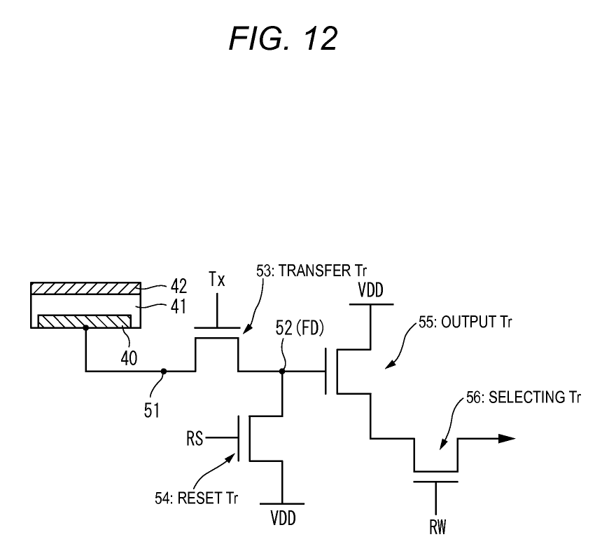

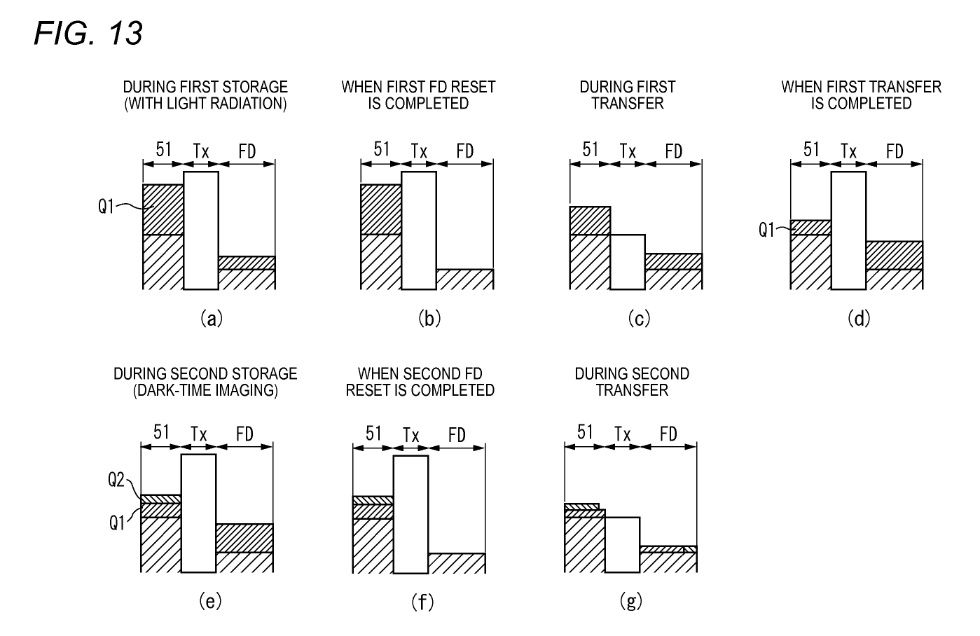

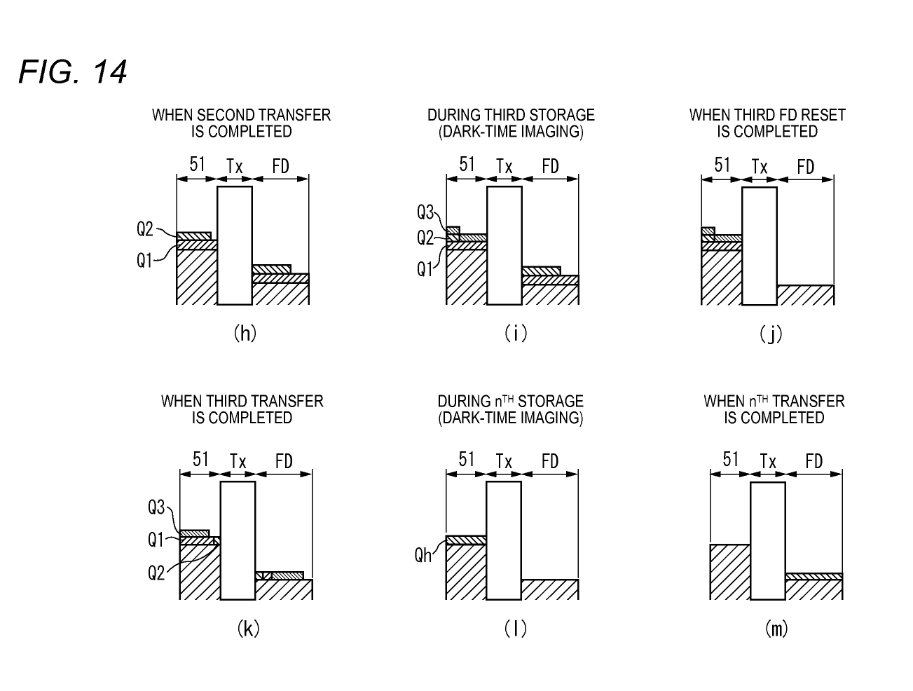

FIG. 11 is a timing chart for describing an imaging operation of two pixel rows of the solid-state imaging element with the configuration shown in FIG. 10. In FIG. 11, “RW” indicates a waveform of a voltage supplied to the row selecting line RW, “Tx1” and “Tx2” indicate waveforms of voltages supplied to transfer control lines Tx1 and Tx2, “RS” indicates a waveform of a voltage supplied to the reset line RS, “RD” indicates a waveform of a voltage supplied to the RD 15 via the reset drain line RDL, “storage unit A” and “storage unit B” indicate potentials of the two electric charge storage units 11 included in the two adjacent pixels 101, and “FD” indicates a potential of the FD 13.

In FIG. 11, in a signal readout period 1, the same driving as shown in FIG. 5 is performed on the upper pixel 101 out of the two pixels 101 except that the transfer transistor 30 of the lower pixel 101 out of the two pixels 101 adjacent in the column direction of FIG. 10 is turned off, and in a signal readout period 2, the same driving as shown in FIG. 5 is performed on the lower pixel 101 out of the two pixels 101 except that the transfer transistor 30 of the upper pixel 101 out of the two pixels 101 adjacent in the column direction of FIG. 10 is turned off. With the driving, electric charges can be individually injected into and discharged from the two pixels 101 sharing a part of the signal readout circuit, and image lags in the pixels can thereby be suppressed.

As described above, the present specification discloses the following configurations.

It is a disclosed solid-state imaging element that has a photoelectric converting layer that is formed above a semiconductor substrate and made of an organic material, and an MOS type signal readout circuit that is formed on the semiconductor substrate and reads out signals according to electric charge generated in the photoelectric converting layer, in which the signal readout circuit includes a first electric charge storage unit that stores electric charge generated in the photoelectric converting layer, a second electric charge storage unit to which the electric charge stored in the first electric charge storage unit is transferred, a transfer transistor that transfers the electric charge stored in the first electric charge storage unit to the second electric charge storage unit, a reset transistor that resets a potential of the second electric charge storage unit, and an output transistor that outputs a signal according to the potential of the second electric charge storage unit, and in which the solid-state imaging element comprises: a control unit that performs, in each frame, driving to inject electric charge into the first electric charge storage unit from a semiconductor region by changing a potential of the semiconductor region in which a power source of the reset transistor is connected from a deep state to a shallow state, and to discharge the electric charge that has been injected into the first electric charge storage unit to the semiconductor region by changing, from this state, the potential of the semiconductor region from the shallow state to a deep state.

With the configuration, since the driving to inject electric charge to the first electric charge storage unit from the semiconductor region in which the power source of the reset transistor is connected and to discharge the electric charge that has been injected to the first electric charge storage unit to the semiconductor region is performed for each frame, the potential of the first electric charge storage unit when storage of the electric charge in the first electric charge storage unit starts can be set to be uniform in each frame, and an image lag can thereby be suppressed. In addition, such an image lag can be suppressed without adding a mechanism for injecting electric charge to the signal readout circuit, and high pixel density and low cost can be attained.

It is the disclosed solid-state imaging element, comprising: a plurality of pixels each having the photoelectric converting layer and the signal readout circuit, in which a part of the signal readout circuit is shared by the plurality of adjacent pixels.

With the configuration, the number of transistors per pixel can be reduced, and reduction of a pixel size and high pixel density can thereby be easily attained.

It is the disclosed solid-state imaging element, in which the plurality of pixels sharing the part of the signal readout circuit share the reset transistor, and in which the control unit performs driving to perform injection and discharge of electric charge in the plurality of pixels individually.

With the configuration, the number of reset transistors per pixel can be reduced, and reduction of a pixel size and high pixel density can thereby be easily attained.

It is the disclosed solid-state imaging element, in which the control unit turns on the transfer transistor when electric charge is injected into the first electric charge storage unit.

With the configuration, since the potential of the semiconductor region does not need to be significantly changed, power consumed can be reduced.

It is the disclosed solid-state imaging element, in which the control unit maintains the transfer transistor turned on even when the electric charge that has been injected into the first electric charge storage unit is discharged to the semiconductor region.

With the configuration, the amount of injected electric charge remaining in the first electric charge storage unit can be controlled.

It is the disclosed solid-state imaging element, in which the control unit completes the discharge of the electric charge that has been injected into the first electric charge storage unit to the semiconductor region by turning off the transfer transistor, and controls an amount of the injected electric charge remaining in the first electric charge storage unit according to a length of a time in which the electric charge that has been injected into the first electric charge storage unit is discharged to the semiconductor region.

With the configuration, the amount of the injected electric charge into the first electric charge storage unit can be controlled according to a time in which the transfer transistor is turned on, and the amount of the injected electric charge is thereby easily controlled.

It is the disclosed solid-state imaging element, in which the control unit turns off the transfer transistor in a state in which a potential of the first electric charge storage unit is more shallow than a potential of a channel region of the transfer transistor decided based solely on a voltage applied to a gate electrode of the transfer transistor when the transfer transistor is turned on.

With the configuration, a time required for injecting electric charge can be shortened.

### INDUSTRIAL APPLICABILITY

It is the disclosed solid-state imaging element, in which the control unit changes the length of the time in which the electric charge that has been injected into the first electric charge storage unit is discharged to the semiconductor region according to a captured scene.

It is a disclosed method of driving a solid-state imaging element that has a photoelectric converting layer that is formed above a semiconductor substrate and made of an organic material, and an MOS type signal readout circuit that is formed on the semiconductor substrate and reads out signals according to electric charge generated in the photoelectric converting layer, in which the signal readout circuit includes a first electric charge storage unit that stores electric charge generated in the photoelectric converting layer, a second electric charge storage unit to which the electric charge stored in the first electric charge storage unit is transferred, a transfer transistor that transfers the electric charge stored in the first electric charge storage unit to the second electric charge storage unit, a reset transistor that resets a potential of the second electric charge storage unit, and an output transistor that outputs a signal according to the potential of the second electric charge storage unit, and in which the method comprises: a drive step of performing, in each frame, driving to inject electric charge into the first electric charge storage unit from a semiconductor region by changing a potential of the semiconductor region in which a power source of the reset transistor is connected from a deep state to a shallow state, and to discharge the electric charge that has been injected into the first electric charge storage unit to the semiconductor region by changing, from this state, the potential of the semiconductor region from the shallow state to a deep state.

It is the disclosed method of driving a solid-state imaging element, in which the solid-state imaging element has a plurality of pixels each having the photoelectric converting layer and the signal readout circuit, and a part of the signal readout circuit is shared by the plurality of adjacent pixels, and in which, in the drive step, driving to perform injection and discharge of electric charge is performed in the plurality of adjacent pixels individually.

It is the disclosed method of driving a solid-state imaging element, in which, in the drive step, the transfer transistor is turned on when electric charge is injected into the first electric charge storage unit.

It is the disclosed method of driving a solid-state imaging element, in which, in the drive step, the transfer transistor is maintained turned on even when the electric charge that has been injected into the first electric charge storage unit is discharged to the semiconductor region.

It is the disclosed method of driving a solid-state imaging element, in which, in the drive step, the discharge of the electric charge that has been injected into the first electric charge storage unit to the semiconductor region is completed by turning off the transfer transistor, and an amount of the injected electric charge remaining in the first electric charge storage unit is controlled according to a length of a time in which the electric charge that has been injected into the first electric charge storage unit is discharged to the semiconductor region.

It is the disclosed method of driving a solid-state imaging element, in which, in the drive step, the transfer transistor is turned off in a state in which a potential of the first electric charge storage unit is more shallow than a potential of a channel region of the transfer transistor decided based solely on a voltage applied to a gate electrode of the transfer transistor when the transfer transistor is turned on.

It is the disclosed method of driving a solid-state imaging element, in which, in the drive step, the length of the time in which the electric charge that has been injected into the first electric charge storage unit is discharged to the semiconductor region is changed according to a captured scene.

It is an disclosed imaging device comprising: the solid-state imaging element.

According to the present invention, it is possible to provide a photoelectric converting layer-stacked solid-state imaging element, and a method of driving the element, and an imaging device with the solid-state imaging element that can attain high image quality, high pixel density, and low cost.

The present invention has been described in detail and with reference to specific embodiments, but it is obvious for those skilled in the art that the present invention can be variously modified or altered without departing from the gist or the scope of the invention.

The present application is based on Japanese Patent Application filed on Jan. 20, 2011 (Japanese Patent Application No. 2011-10282), and the content thereof is incorporated herein by reference.

### REFERENCE SIGNS LIST

100 solid-state imaging element

104 control unit

10 semiconductor substrate

11 electric charge storage unit

13 floating diffusion (FD)

30 transfer transistor

31 reset transistor

32 output transistor

S signal readout circuit

1. A solid-state imaging element that has a photoelectric converting layer that is formed above a semiconductor substrate and made of an organic material, and an MOS type signal readout circuit that is formed on the semiconductor substrate and reads out signals according to electric charge generated in the photoelectric converting layer,
wherein the signal readout circuit includes a first electric charge storage unit that stores electric charge generated in the photoelectric converting layer, a second electric charge storage unit to which the electric charge stored in the first electric charge storage unit is transferred, a transfer transistor that transfers the electric charge stored in the first electric charge storage unit to the second electric charge storage unit, a reset transistor that resets a potential of the second electric charge storage unit, and an output transistor that outputs a signal according to the potential of the second electric charge storage unit, and
wherein the solid-state imaging element comprises:
a control unit that performs, in each frame, driving to inject electric charge into the first electric charge storage unit from a semiconductor region by changing a potential of the semiconductor region in which a power source of the reset transistor is connected from a deep state to a shallow state, and to discharge the electric charge that has been injected into the first electric charge storage unit to the semiconductor region by changing, from this state, the potential of the semiconductor region from the shallow state to a deep state.

2. The solid-state imaging element according to claim 1, comprising:
a plurality of pixels each having the photoelectric converting layer and the signal readout circuit,
wherein a part of the signal readout circuit is shared by the plurality of adjacent pixels.

3. The solid-state imaging element according to claim 2,
wherein the plurality of pixels sharing the part of the signal readout circuit share the reset transistor, and
wherein the control unit performs driving to perform injection and discharge of electric charge in the plurality of pixels individually.

4. The solid-state imaging element according to claim 1,
wherein the control unit turns on the transfer transistor when electric charge is injected into the first electric charge storage unit.

5. The solid-state imaging element according to claim 4,
wherein the control unit maintains the transfer transistor turned on even when the electric charge that has been injected into the first electric charge storage unit is discharged to the semiconductor region.

6. The solid-state imaging element according to claim 5,
wherein the control unit completes the discharge of the electric charge that has been injected into the first electric charge storage unit to the semiconductor region by turning off the transfer transistor, and controls an amount of the injected electric charge remaining in the first electric charge storage unit according to a length of a time in which the electric charge that has been injected into the first electric charge storage unit is discharged to the semiconductor region.

7. The solid-state imaging element according to claim 6,
wherein the control unit turns off the transfer transistor in a state in which a potential of the first electric charge storage unit is more shallow than a potential of a channel region of the transfer transistor decided based solely on a voltage applied to a gate electrode of the transfer transistor when the transfer transistor is turned on.

8. The solid-state imaging element according to claim 6,
wherein the control unit changes the length of the time in which the electric charge that has been injected into the first electric charge storage unit is discharged to the semiconductor region according to a captured scene.

9. A method of driving a solid-state imaging element that has a photoelectric converting layer that is formed above a semiconductor substrate and made of an organic material, and an MOS type signal readout circuit that is formed on the semiconductor substrate and reads out signals according to electric charge generated in the photoelectric converting layer,
wherein the signal readout circuit includes a first electric charge storage unit that stores electric charge generated in the photoelectric converting layer, a second electric charge storage unit to which the electric charge stored in the first electric charge storage unit is transferred, a transfer transistor that transfers the electric charge stored in the first electric charge storage unit to the second electric charge storage unit, a reset transistor that resets a potential of the second electric charge storage unit, and an output transistor that outputs a signal according to the potential of the second electric charge storage unit, and
wherein the method comprises:
a drive step of performing, in each frame, driving to inject electric charge into the first electric charge storage unit from a semiconductor region by changing a potential of the semiconductor region in which a power source of the reset transistor is connected from a deep state to a shallow state, and to discharge the electric charge that has been injected into the first electric charge storage unit to the semiconductor region by changing, from this state, the potential of the semiconductor region from the shallow state to a deep state.

10. The method of driving a solid-state imaging element according to claim 9,
wherein the solid-state imaging element has a plurality of pixels each having the photoelectric converting layer and the signal readout circuit, and a part of the signal readout circuit is shared by the plurality of adjacent pixels, and
wherein, in the drive step, driving to perform injection and discharge of electric charge is performed in the plurality of adjacent pixels individually.

11. The method of driving a solid-state imaging element according to claim 9,
wherein, in the drive step, the transfer transistor is turned on when electric charge is injected into the first electric charge storage unit.

12. The method of driving a solid-state imaging element according to claim 11,
wherein, in the drive step, the transfer transistor is maintained turned on even when the electric charge that has been injected into the first electric charge storage unit is discharged to the semiconductor region.

13. The method of driving a solid-state imaging element according to claim 12,
wherein, in the drive step, the discharge of the electric charge that has been injected into the first electric charge storage unit to the semiconductor region is completed by turning off the transfer transistor, and an amount of the injected electric charge remaining in the first electric charge storage unit is controlled according to a length of a time in which the electric charge that has been injected into the first electric charge storage unit is discharged to the semiconductor region.

14. The method of driving a solid-state imaging element according to claim 13,
wherein, in the drive step, the transfer transistor is turned off in a state in which a potential of the first electric charge storage unit is more shallow than a potential of a channel region of the transfer transistor decided based solely on a voltage applied to a gate electrode of the transfer transistor when the transfer transistor is turned on.

15. The method of driving a solid-state imaging element according to claim 13,
wherein, in the drive step, the length of the time in which the electric charge that has been injected into the first electric charge storage unit is discharged to the semiconductor region is changed according to a captured scene.

16. An imaging device comprising:
the solid-state imaging element according to claim 1.
